(19) United States
(12) Patent Application Publication
(10) Pub. No.: US 2019/0183163 A1
(43) Pub. Date: Jun. 20, 2019

(54) KIT FOR CREATING A RAW FOOD BAR AND METHOD OF USE

(71) Applicant: Nutsola LLC, West Orange, NJ (US)

(72) Inventors: Michael KUKOFF, West Orange, NJ (US); Adam KUKOFF, West Orange, NJ (US)

(21) Appl. No.: 16/227,754

(22) Filed: Dec. 20, 2018

Related U.S. Application Data
(60) Provisional application No. 62/608,164, filed on Dec. 20, 2017.

(51) Int. Cl. A23P 30/20; A23L 7/126; A23L 19/00; A23L 25/00; A23P 10/28

(52) U.S. Cl. CPC A23P 30/20; A23L 7/126; A23V 2002/00; A23L 25/20; A23P 10/28; A23L 19/03

(57) ABSTRACT

A kit for the in-home production of one or more raw food bars is provided. The kit features an amount of one or more raw foods, a die, a plurality of plates, and a dehydration apparatus. Further, a method of producing one or more raw food bars by using said kit is provided.

### CLAIM OF PRIORITY

This application is a non-provisional application which claims priority to U.S. Provisional Patent Application No.: 62/608,164 filed on Dec. 20, 2017, entitled “Kit For Creating A Raw Food Bar And Method Of Use” the contents of which are hereby incorporated by reference, including their specifications.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The present disclosure relates generally to a kit for making raw foods bars and its method of use. More particularly, the present disclosure relates to a kit for making a nut and grain-based raw food bar that is dehydrated at no more than 150° F.

### BACKGROUND

People like eating healthfully, as doing so confers many benefits. A proper and balanced diet can reduce the risk of heart disease, type 2 diabetes, high blood pressure, as well as a myriad of other conditions. According to the U.S. Department of Health and Human Services, “[t]he link between good nutrition and healthy weight, reduced chronic disease risk, and overall health is too important to ignore.” In an effort to eat healthfully, the search for the most nutrition-packed foods has led to the eating of unprocessed foods, organic foods, and raw foods.

That said, eating raw foods provides benefits simply by being a healthy food. Specifically, eating raw foods allows the consumer to pair the unadulterated nutrition of raw foods with an environmentally conscious philosophy surrounding the growing and consumption of raw foods. Today, companies are now using the convictions of the raw food consumer to pivot their businesses to address a rapidly changing and budding raw food market.

Further, the United States Department of Agriculture (USDA) has also taken notice of these trends stating, “Consumers prefer organically produced food because of their concerns regarding health, the environment, and animal welfare, and they show a willingness to pay the price premiums established in the marketplace.” This is true for raw foods as well.

A typical raw diet consists of vegetables, nuts, seeds, and fruits consumed in an unprocessed state. Further, many raw food enthusiasts rely on raw nuts and seeds as a main source of protein for their bodies.

The ability to control the types of ingredients that go into the production of a raw food bar is essential to the maintaining of healthy raw food lifestyle practices. There are plenty of companies who sell healthy food bars at exorbitant prices, but the average person should be able to easily create their own raw food bar snacks without being held at the mercy of companies' price point. Moreover, having the ability to control the types of ingredients that go into the snack is vital for maintaining certain diets.

Cooking and meal prepping takes time and energy, and when consumers purchase these pre-made meals and snacks, they are sacrificing the quality of ingredients for the time it takes to make them. More often than not, these products contain heavily processed ingredients, and are not as well-regulated. In fact, some food bars are misrepresenting the nutritional facts and health benefits associated with their products.

Appliances and devices that handle these ingredients while upholding the nutritional integrity contained in the raw items is a desired market that needs to be strengthened. While juicers and blenders dominate the raw appliance market, a way for a person to efficiently create their own raw food bar at home is completely unavailable. Just as there is a demand for more raw products, there is a demand for systems that help in the preparation of these raw ingredients.

Today, making raw food bars at home is not as convenient as it should be. The use of blenders changes the texture and composition of the food too much. Solid food bars that have ridges, grooves, and other textures are best achieved through handmade preparation. When preparing handmade food products, it is often difficult to maintain consistency in the shape and texture. Having a tool or device that is relatively inexpensive that can facilitate the making of one's own raw food bar is a desired product that is lacking in the raw foods industry.

### SUMMARY

An aspect of an example embodiment in the present disclosure is to provide a kit for making one or more raw food bars.

Accordingly, the present disclosure describes a kit for the in-home production of one or more raw food bars. The kit features an amount of one or more raw foods, a die, a plurality of plates, and a dehydration apparatus. Preferably, the raw foods comprise one or more of the following: almonds, walnuts, pecans, peanuts, cashews, dates, raisins, cranberries, bananas, figs, pineapple, mango, coconut, chia, flax, millet, quinoa, sesame, wheat berries, oats, cacao, cocoa, and amaranth. In many embodiments, the die has a top end, a bottom end, and a number of walls that extend therebetween. Each of the walls has a lip, and these lips form a backstop which will act as a stopper for each of the plurality of plates. Preferably, the portion of each of the walls that extends from a midpoint to the top end will have a different texture than the portion of each of the walls that extends from the midpoint to the bottom end. Also, preferably, each of the plurality of plates will have a top side, a bottom side, a front end, a rear end, a left side, a right side, and a thickness. Additionally, each of the plurality of plates is configured to interface with the die. In various embodiments, each of the plurality of plates will have a thickness that is different than the other plates. However, in other embodiments, each plate has the same thickness for improved interchangeability. Further, when a plate is interfaced with the die by resting against the backstop, the plate will form an empty space between said plate and the bottom end. This empty space is used to be filled with the amount of raw foods. Preferably, the die is shaped such that an interfaced plate may be ejected by applying force through the top surface. In some embodiments, after the empty space has been filled with the blend, an additional plate is used to compress the blend within the die.

The present disclosure also provides for a method of making one or more raw food bars. Preferably, the following steps are performed. First a kit comprising an amount of one or more raw foods, a die, a plurality of plates configured to interface with the die, and a dehydration apparatus is provided. Then a predetermined amount of one or more raw foods is obtained and then is subsequently placed into a container. From there, a corresponding amount of water is added into the container. A mixture of the raw foods and the water is formed by agitating the two within the container, creating a partially hydrated mixture, which preferably has the consistency of a paste. Once the partially hydrated mixture has been formed, one of the plates gets interfaced with the die such that an empty space is formed. The partially hydrated mixture is then packed into this empty space. In some other embodiments, an additional plate is placed on top of the partially hydrated mixture and is used to further compress said mixture. The die is then inverted onto a rigid member, which is preferably coated with parchment paper or a similar substance. The plate is then pushed, through the top of the die such that a compacted mixture is deposited on the rigid member. This is repeated until a desired amount of raw food bars are formed. From there, the formed food bars are placed into a dehydration apparatus at a temperature no greater than 150° F., preferably within the 118° F. to 150° F. range. Preferably, the raw foods are selected from the group consisting essentially of one or more of the following: almonds, walnuts, pecans, peanuts, cashews, dates, raisins, cranberries, bananas, figs, pineapple, mango, coconut, chia, flax, millet, quinoa, sesame, wheat berries, oats, and amaranth.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features.

In the present disclosure, where a document, act, or item of knowledge is referred to or discussed, this reference or discussion is not an admission that the document, act, item of knowledge, or any combination thereof that was known at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed. It is contemplated that the claims may encompass one or more of the conventional technical aspects discussed herein.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### BRIEF DESCRIPTION OF THE PREFERRED EMBODIMENTS

In the drawings, like elements are depicted by like reference numerals. The drawings are briefly described as follows.

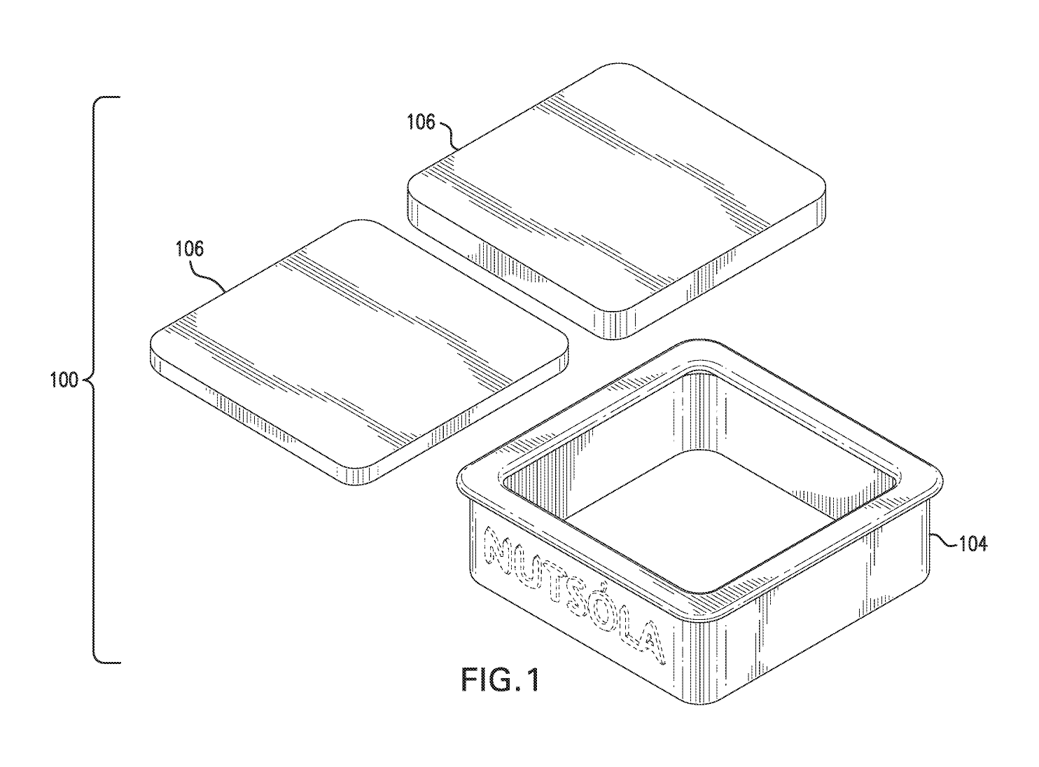

FIG. 1 is a perspective view of an embodiment of a die and two plates of the kit in accordance with the present disclosure.

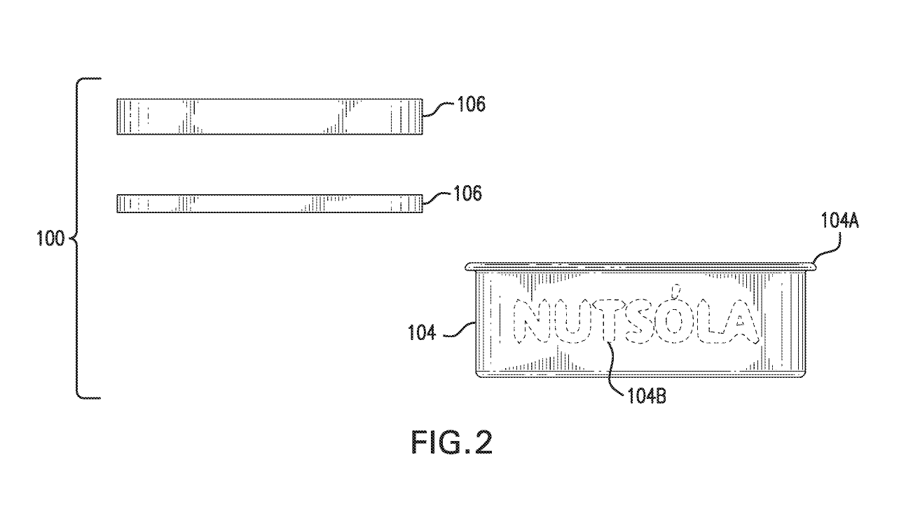

FIG. 2 is a front view of the embodiment of FIG. 1.

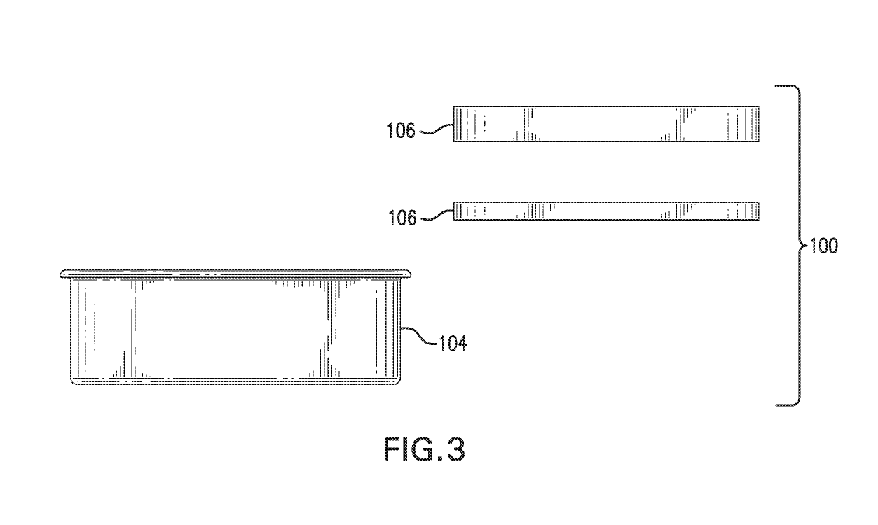

FIG. 3 is a back view of the embodiment of FIG. 1.

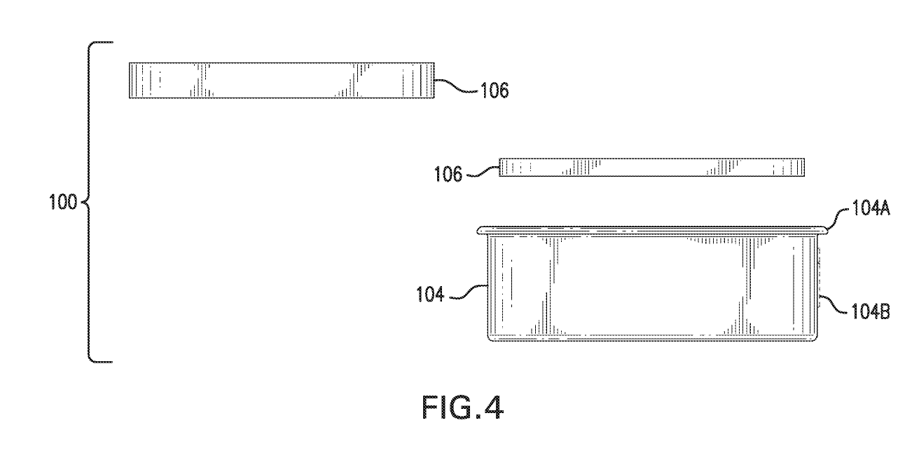

FIG. 4 is a right-side view of the embodiment of FIG. 1.

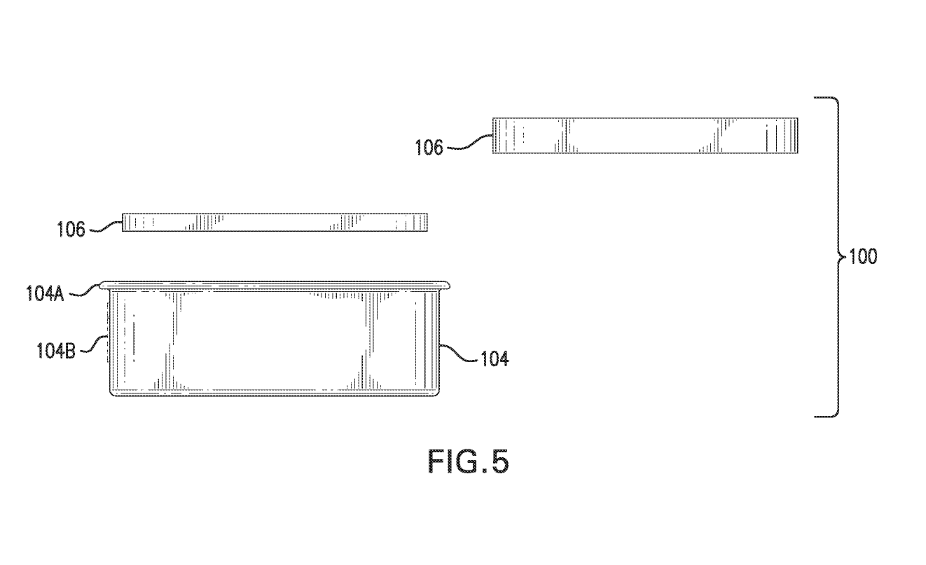

FIG. 5 is a left-side view of the embodiment of FIG. 1.

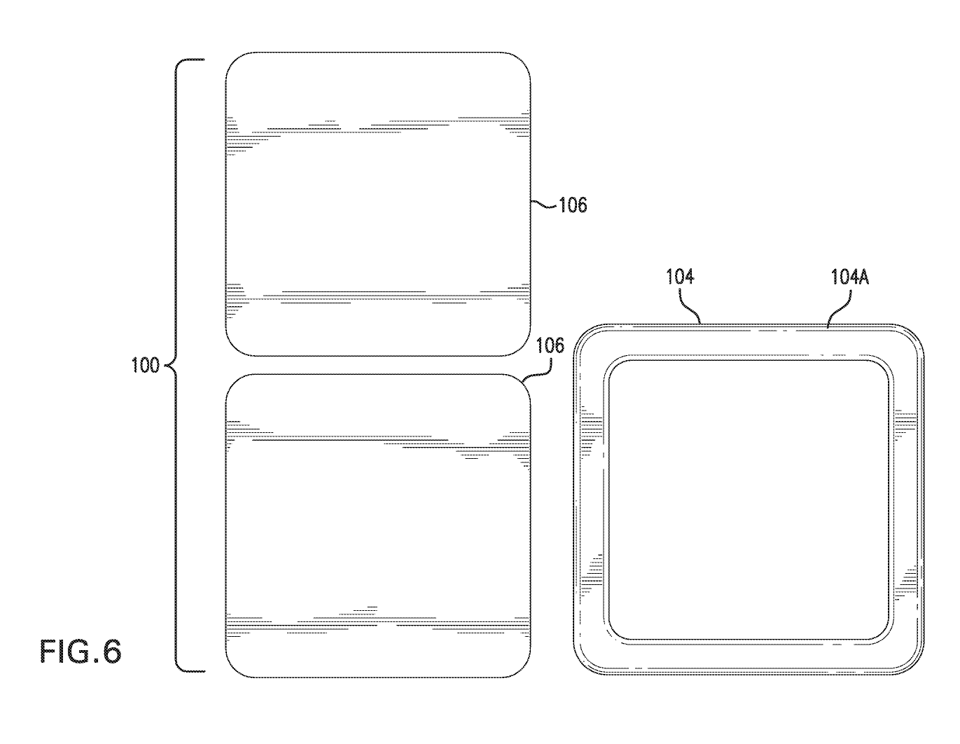

FIG. 6 is a top view of the embodiment of FIG. 1.

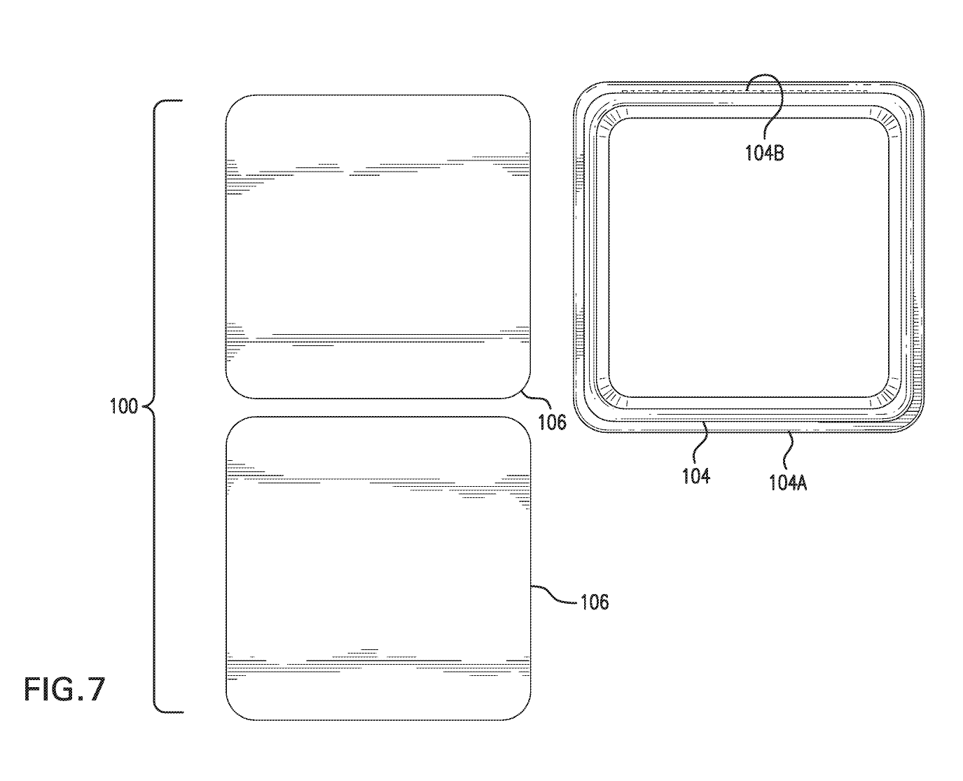

FIG. 7 is a bottom view of the embodiment of FIG. 1.

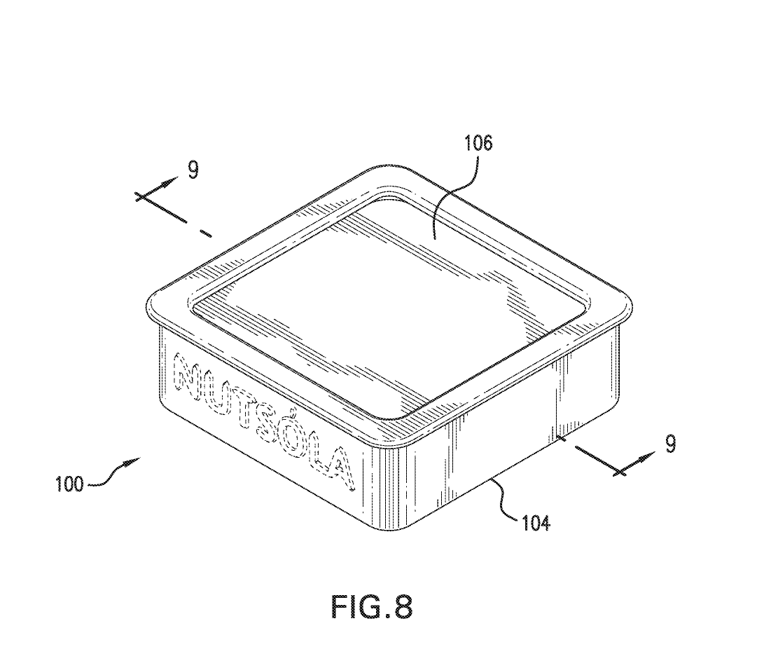

FIG. 8 is a perspective view of the embodiment of FIG. 1, where the die is interfaced with the two plates.

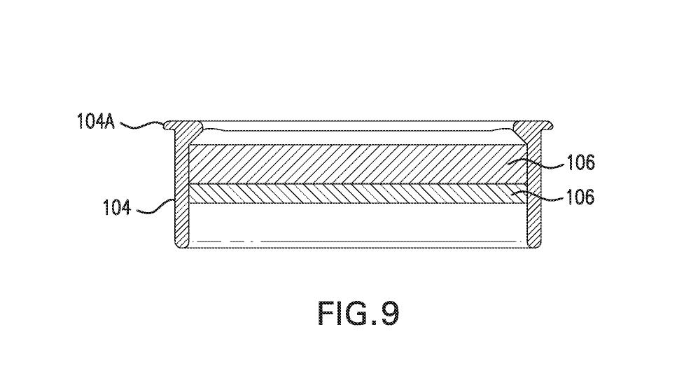

FIG. 9 is a cross-sectional view of the embodiment of FIG. 1, where the die is interfaced with the two plates.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DETAILED DESCRIPTION OF THE PREFERRED EMBODIMENTS

For the purposes of the present disclosure, the term “raw” is intended to mean goods that have not been heated to temperatures above 150° F. FIG. 1 illustrates a perspective view of an embodiment of a die 104 and two plates 106 comprising a kit 100 in accordance with the present disclosure. Here, the die 104 has a top end, a bottom end, and a plurality of walls that extend therebetween. Preferably, there will be four walls to have the die 104 resemble a rectangular prism, but more or fewer walls may be used to create different geometries. The plurality of walls are equipped with a lip 104A, where each of these lips 104A collectively forms a backstop for either or both of the two plates 106.

Referring to the two plates 106 shown in FIG. 1, each plate 106 has a top side, a bottom side, a front end, a rear end, a right side, and a left side. Further, each plate 106 has a thickness, and the thickness of each plate 106 is preferably unique to that plate 106. Plates 106 with different thicknesses can be used to form raw food bars of various sizes. Each plate 106 is sized to interface with the die 104 such that it will rest evenly on the backstop when interfaced with the die 104. Of note is the empty space that is formed between the bottom side of the plates 106 and the bottom end of the die 104. This empty space forms the perimeter for the raw food bar to be constructed in, and is configured to receive an amount of a partially hydrated mixed of one or more raw foods.

FIGS. 2, 3, 4, and 5 show a front view, back view, right-side view, and left side view of the kit 100, respectively. Each of FIGS. 2, 3, 4, and 5 include the die 104 and two of the plates 106 in accordance with the present disclosure. Of note here is the substantial symmetry of the die 104 and the plates 106, which has the benefit of producing raw foods bars that are visually pleasing and of uniform dimensions.

Referring to FIGS. 6 and 7, a top view and a bottom view of the kit 100 is provided, respectively. As can be seen here, the empty space formed by the plate 106 and the die 104 will have a substantially similar outer perimeter. This shows how the plate 106 and the die 104 are sized in a complimentary fashion such that when the plate 106 interfaces with the die 104, a limited friction fit is achieved between the two components. The uniform size allows the user to better track calorie and macronutrient consumption, based on the composition of the bar.

FIG. 8 displays a perspective view of the die 104 interfaced with the two plates 106, forming an embodiment of the kit 100. In a preferred embodiment, when placed into the die 104, the two plates 106 form the inserted ingredients forming a cavity in which the raw food bar will be formed. Specifically, the cavity formed by the bottom end of the die 104, the interfaced plate 106, and a rigid member below the die 104 is where the raw food bar is formed. This rigid member is preferably a flat surface such as a tabletop or cooking tray. Once the raw food has been placed in this cavity, a human user may eject the bar exerting force through the top end of the die 104 to the top side of the plate 106. In this view, again, the thicknesses of the two plates 106 can impact the size of raw food bars that can be made, because the size of the cavity will differ based on the thickness of the plate 106 interfaced with the die 104.

FIG. 9 shows a cross-sectional view of the embodiment of the die 104 interfaced with the two plates 106. Here, both plates 106 can be seen inside the die 104. The space below the plates 106 is reserved for the raw ingredients. The plates 106 push down on the ingredients using the walls of the die 104 to maintain shape consistency of the food bars. Further, FIG. 9 shows the lip 104A, which is used to provide the user with additional surface area to eject the plate(s) 106 and the raw food bar formed by the interfaced die 104 and plate(s) 106.

The present disclosure also provides for using the kit 100 of the present disclosure to make a number of edible raw food bars. This method of creating foods bars utilizes an amount of one or more raw foods. Preferably, this will be a blend of seeds, nuts, and spices. This blend is then placed into a container and combined with a corresponding amount of water. Preferably, this will be a ratio of 8:1 blend-to-water by volume. In other embodiments, two tablespoons of water is combined with one pound of the blend of raw foods described above. Note that the container can be a rigid container or a malleable container, provided that the container is substantially water-tight. The blend and water are mixed together until a paste-like consistency is achieved. The blend and water may be mixed with a tool such as a spoon, or may simply be mixed by the user's hand. In a preferred embodiment, a flexible container is used and the blend and water are agitated by deforming the container through external force.

Once the raw food blend and water are combined, a particular plate 106 is selected based on desired thickness. The selected plate 106 is then interfaced with the backstop of the die 104A. This interfacing creates and empty space which is used to receive a portion of the paste-like mixture. The mixture is then placed in the empty space, the die 104 is inverted such that the top side is placed on a rigid member, such as a table top. Preferably, the rigid member will be covered with a substance such as parchment paper. While inverted, force is exerted through the top end of the die 104 onto the bottom end of the plate 106. This has the effect of ejecting the plate 106 from the die 104, compacting the paste-like mixture, and ejecting the compacted mixture from the die 104. In some embodiments, the plate 106 must be removed separately from the compacted mixture. The above steps are repeated until a desired amount of substantially uniformly-sized amount of compacted mixtures are formed. These substantially uniformly-sized amounts are then placed into a dehydrator for a period of time. Preferably, the dehydrator will not go above 150° F. so that the raw foods stay in their raw form, while also dehydrating the mixture into a bar that can be easily consumed by humans. More preferably, the dehydrator will operate within the range of 118° F. to 150° F.

In a preferred embodiment, the raw foods used in connection with the present disclosure are some blend containing one or more of the following: almonds, walnuts, pecans, peanuts, cashews, dates, raisins, cranberries, bananas, figs, pineapple, mango, coconut, chia, flax, millet, quinoa, sesame, wheat berries, oats, cacao, cocoa, and amaranth, as well as some amount of spices. This mixture can be varied to suit the user's taste, or can be varied to accommodate the harvesting season of each of those foods. In some embodiments all of these raw foods are used, while in other embodiments select choices of said group are used. In other embodiments, the kit 100 in accordance with the present disclosure is used in a commercial or pseudo-commercial setting where the raw foods bars are made and are then individually packaged and sold.

In some embodiments, each of these plurality of walls of the die has a midpoint which collectively form a shelf about halfway between the top end and the bottom end. Note that the placement of the shelf can be moved depending on the ultimate size of food bars that is desired. In some embodiments, the die 104 has two textures: a first texture that extends from the shelf to the top end; and a second texture that extends from the shelf to the bottom end.

In this view, the empty space created by the plate 106 and die 104 is considerably smaller than when a plate 106 having a lower thickness is used. This variable configuration allows users to make bars having a quantized size. As stated earlier, the size of bars that can be made be in specific amounts is beneficial for a user looking to keep rigorous track of their calorie and macronutrient intake.

In a preferred embodiment of the method of the present invention, multiple raw food bars can be formed simultaneously. This embodiment of the method begins by providing a tray having raised walls. The blend of raw food ingredients is placed in the tray, substantially covering the bottom of the tray. Preferably, one of the raised walls of the tray will have one or more openings to accommodate any excess raw ingredients. Once the raw ingredients are placed in the tray, a rolling pin is used to achieve substantial uniformity of the ingredients throughout the tray. During this rolling process is likely when the excess ingredients will move through the openings, in the embodiments of the tray that include said openings. One embodiment of the method proceeds by placing one or more multi-bar dies into the rolled ingredients. A single multi-bar die may be used if the die is sized to interface along the perimeter of the raised walls. Alternatively, a smaller die may be pushed into the rolled ingredients multiple times to convert the rolled ingredients into uniformly-sized bars. In yet another embodiment, the rolled ingredients are struck such that bark-like pieces of the raw food ingredients are formed. Regardless of which of the above embodiments are used, the method then proceeds where the raw food bars or bark-like pieces are placed in a dehydration apparatus. Preferably, the dehydrator will not go above 150° F. so that the raw foods stay in their raw form, while also dehydrating the mixture into a bar that can be easily consumed by humans. More preferably, the dehydrator will operate within the range of 118° F. to 150° F.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a kit 100 for the in-home production of one or more raw food bars. The disclosure is illustrated by example in the drawing figures, and throughout the written description. It should be understood that numerous variations are possible while adhering to the inventive concept. Such variations are contemplated as being a part of the present disclosure.

What is claimed is:

1. A kit for the in-home production of one or more raw food bars, comprising:
an amount of one or more raw foods;
a die having a top end, a bottom end, and a plurality of walls extending therebetween,
wherein each of the plurality of walls has a lip, the lip of each of the plurality of walls being configured to form a backstop; and
a plurality of plates, each plate having a top side, a bottom side, a front end, a rear end, a left side, a right side, and a thickness,
wherein each of the plurality of plates is configured to interface with the backstop.

2. The kit of claim 1, further comprising an apparatus for dehydration.

3. The kit of claim 2, where the raw foods are selected from the group consisting essentially of: almonds, walnuts, pecans, peanuts, cashews, dates, raisins, cranberries, bananas, figs, pineapple, mango, coconut, chia, flax, millet, quinoa, sesame, wheat berries, oats, cacao, cocoa, and amaranth.

4. The kit of claim 2, the plurality of plates being a first plate and a second plate,
wherein the first plate has a first thickness and the second plate has a second thickness.

5. The kit of claim 4, wherein when the first plate is interfaced with the backstop, an empty space is formed between the bottom end and the first plate.

6. The kit of claim 4, wherein when the second plate is interfaced with the die, an empty space is formed between the bottom end and the second plate.

7. The kit of claim 5, wherein the top end is open such that the first plate may be ejected by applying force through the top end.

8. The kit of claim 6, wherein the top end is open such that the second plate may be ejected by applying force through the top end.

9. A method of making one or more raw food bars, comprising the steps of:
a. providing a kit, comprising:
an amount of one or more raw foods;
a die having a top end, a bottom end, and a plurality of walls extending therebetween,
wherein each of the plurality of walls has a lip, the lip of each of the plurality of walls being configured to form a backstop,
a plurality of plates, each plate having a top side, a bottom side, a front end, a rear end, a left side, a right side, and a thickness,
wherein each of the plurality of plates is configured to interface with the backstop; and
a dehydration apparatus;
b. obtaining a predetermined amount of one or more raw foods and placing the amount of one or more raw foods into a container;
c. adding a corresponding amount of water into the container;
d. forming a mixture by mixing the water with the amount of one or more raw foods until the amount of one or more raw foods is partially hydrated;
e. placing one of the plurality of the plates in the die, such that the plate interfaces with the backstop of the die, creating an empty space between the plate and the bottom end;
f. packing a portion of the mixture into the empty space;
g. placing the bottom end of the die directly on a rigid member;
h. pushing the plate, through the top end such that the portion of the mixture is compacted and subsequently removed from the die, forming a raw food bar; and
i. repeating steps a-h until a desired amount of raw food bars have been formed.

10. The method of claim 9, further comprising the steps of:
j. placing the one or more raw food bars into the dehydration apparatus;
k. dehydrating the one or more raw food bars at a predetermined temperature for a predetermined amount of time; and
l. removing the one or more dehydrated raw food bars.

11. The method of claim 10, wherein the predetermined temperature is no more than 150° F.

12. The method of claim 11, wherein the predetermined temperature is in the range of 118° F. to 150° F.

13. The method of claim 11, the one or more raw foods being selected from the group consisting of: almonds, walnuts, pecans, peanuts, cashews, dates, raisins, cranberries, bananas, figs, pineapple, mango, coconut, chia, flax, millet, quinoa, sesame, wheat berries, oats, and amaranth.

14. The method of claim 12, wherein the amount of water and the amount of one or more foods are present in a ratio of 1:8 by volume.

15. The method of claim 13, where the rigid member is covered with parchment paper upon which the raw food bar is formed.
